(19) United States
(12) Patent Application Publication
(10) Pub. No.: US 2020/0028455 A1
(43) Pub. Date: Jan. 23, 2020

(54) MOTOR DEVICE AND VEHICLE-MOUNTED SEAT AIR CONDITIONER

(71) Applicant: SHINANO KENSHI CO., LTD., Ueda-shi, Nagano (JP)

(72) Inventors: Yuki KOSAKA, Nagano (JP); Masayuki NISHIHARA, Nagano (JP); Nobuchika MARUYAMA, Nagano (JP); Kazuhiro KOBAYASHI, Nagano (JP)

(73) Assignee: SHINANO KENSHI CO., LTD., Ueda-shi, Nagano (JP)

(21) Appl. No.: 16/483,904

(22) PCT Filed: Oct. 4, 2018
(86) PCT No.: PCT/JP2018/037242

§ 371 Date: Aug. 6, 2019

(30) Foreign Application Priority Data
Dec. 5, 2017 (JP) 2017-233781

(51) Int. Cl. H02P 6/15; H02P 6/182; B60H 1/00

(52) U.S. Cl. CPC H02P 6/157; H02P 2207/05; B60H 1/00285; H02P 6/182

(57) ABSTRACT

A motor device includes: a motor body including a rotor, multi-phase coils for rotating the rotor, and an oil-retaining bearing supporting the rotor for rotation; and a drive control unit detecting a position of the rotor based on counter electromotive force of any of the multi-phase coils, and controlling energization of the multi-phase coils according to the position of the rotor, wherein the drive control unit feedback-controls energization of the multi-phase coils such that rotational speed of the rotor does not fall below a threshold value at which detection of rotational position of the rotor based on the counter electromotive force is impossible.

### TECHNICAL FIELD

The present invention relates to a motor device and a vehicle-mounted seat air conditioner.

### BACKGROUND ART

There is conventionally known a motor device, in which a position of a rotor is detected based on counter electromotive force of a coil, and the energization of the coil is switched according to the position of the rotor (see, for example, Patent Document 1).

### PRIOR ART DOCUMENT

### Patent Document

[Patent Document 1] Japanese Unexamined Patent Application Publication No. 2017-070123

### SUMMARY OF THE INVENTION

### Problems to be Solved by the Invention

Such a motor main body uses an oil-retaining bearing. For example, under low temperature environment, viscosity of the oil in the oil-retaining bearing might increase, and the rotational speed of the rotor might decrease. When the rotational speed of the rotor decreases, the counter electromotive force of the coil might decrease, and the position of the rotor might not be accurately detected, and the rotation of the rotor might not be finely controlled.

The present invention has been made in view of the above problems and has an object to provide a motor device and a vehicle-mounted seat air conditioner having the same in which rotation of a rotor is finely controlled even under low temperature environment.

### Means for Solving the Problems

The above object is achieved by a motor device including: a motor body including a rotor, multi-phase coils for rotating the rotor, and an oil-retaining bearing supporting the rotor for rotation; and a drive control unit detecting a position of the rotor based on counter electromotive force of any of the multi-phase coils, and controlling energization of the multi-phase coils according to the position of the rotor, wherein the drive control unit feedback-controls energization of the multi-phase coils such that rotational speed of the rotor does not fall below a threshold value at which detection of rotational position of the rotor based on the counter electromotive force is impossible.

The above object is achieved by a vehicle-mounted seat air conditioner including the above-described motor device.

### Effects of the Invention

According to the present invention, it is possible to provide a motor device and a vehicle-mounted seat air conditioner having the same in which rotation of a rotor is finely controlled even under low temperature environment.

### BRIEF DESCRIPTION OF THE DRAWINGS

FIG. 1 is a cross-sectional view of a air blower according to a present embodiment;

FIG. 2 is a schematic view of a part of an air conditioning system into which the air blower is incorporated; and

FIG. 3 is a time chart illustrating a change in the rotational speed of a rotor.

### MODES FOR CARRYING OUT THE INVENTION

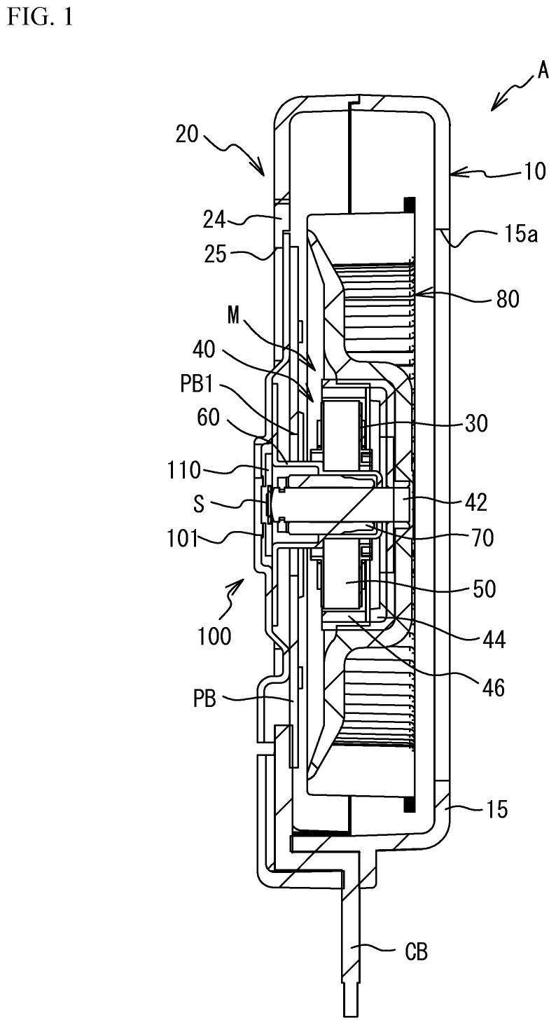

FIG. 1 is a cross-sectional view of a air blower A according to a present embodiment. The air blower A includes an upper case 10, a lower case 20, a fan 80, and the like. The upper case 1.0 and the lower case 20 are assembled and fixed to each other in an axial direction of the fan 80. The upper case 10 and the lower case 20 cooperatively define a single scroll-like case. The upper case 10 and the lower case 20 are made of synthetic resin. An upper wall portion 15 of the upper case 10 is formed with an opening 15a through which air passes in response to the rotation of the fan 80

An opening 25 is formed substantially at the center of a bottom wall portion 24 of the lower case 20. The opening 25 is closed by a base plate 100. An opening 101 is formed substantially at the center of the base plate 100. The opening 101 is closed by a housing 60 and a thrust cover 110. The base plate 100 supports the fan 80 and a motor main body M that rotates the fan 80. From between the upper case 10 and the lower case 20, a cable CB electrically connected to the motor main body M is drawn out in the upper case 10 and the lower case 20, the fan 80 and the motor main body M are accommodated. Additionally, in the upper case 10 and the lower case 20, air is introduced from the opening 15a and is discharged from an opening not illustrated, in response to the rotation of the fan 80. The air blower A is used in, for example, an air conditioner for a seat mounted on a vehicle. The fan 80 is a centrifugal multi-blade fan.

The motor main body M will be described. The motor main body M includes coils 30, a rotor 40, a stator 50, the housing 60, and the like. The stator 50 has a substantially annular shape and is made of metal. The stator 50 is fixed to an outer circumferential surface of the housing 60. The housing 60 is fixed to an inner bottom surface of the base plate 100. An oil-retaining bearing 70 for rotatably holding a rotational shaft 42 is press-fitted into the housing 60. The oil-retaining bearing 70 is specifically a sintered oil-retaining bearing.

The coils 30 are wound around the stator 50 via an insulator. The coils 30 are electrically connected to a printed circuit board PB. The printed circuit board PB is formed by forming a conductive pattern on a rigid insulating board. The printed circuit board PB is fixed to and supported by the inner surface side of the base plate 100, and is formed with an opening PB1 through which the housing 60 passes. Electronic components for supplying electric power to the coils 30 are mounted on the printed circuit board PB. The electronic components are, for example, an output transistor (switching element) such as an FET for controlling the energization state of the coils 30, a capacitor, and the like. The cable CB is electrically connected to the printed circuit board PB. The stator 50 is excited by energizing the coils 30.

The rotor 40 includes the rotational shaft 42, a yoke 44, and one or more permanent magnets 46. The rotational shaft 42 is rotatably supported by the oil-retaining bearing 70. A lower end of the rotational shaft 42 is supported by the thrust cover 110 via a thrust receiver S. The yoke 44 is fixed to an end of the rotational shaft 42 protruding upward from the housing 60, and the yoke 44 rotates together with the rotational shaft 42. The yoke 44 has a substantially cylindrical shape and is made of metal. The fan 80 is fixed to the upper side of the yoke 44. One or more permanent magnets 46 are fixed to the inner circumferential side surface of the yoke 44. The permanent magnet 46 faces the outer circumferential surface of the stator 50. The stator 50 is excited by energizing the coils 30. This causes magnetic attraction force and magnetic repulsive force to act between the permanent magnet 46 and the stator 50. The action of the magnetic force causes the yoke 44, that is, the rotor 40 to rotate relatively to the stator 50. Thus, the rotor 40 is an outer rotor, and the motor main body M is an outer rotor type motor. The rotation of the rotor 40 causes the fan 80 to rotate.

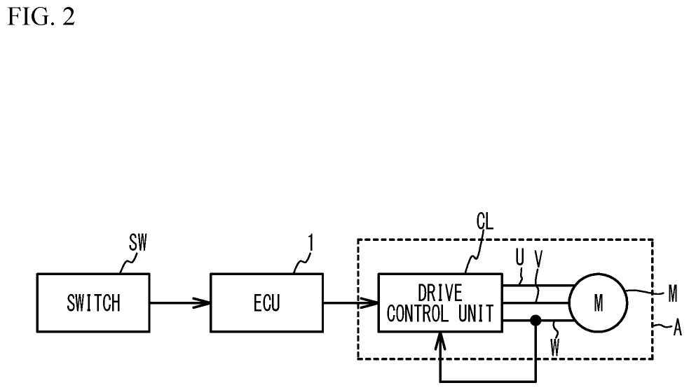

Next, a description will be given of a part of an air conditioning system into which the air blower A is incorporated. FIG. 2 is a schematic view of a part of an air conditioning system into which the air blower A is incorporated. As described above, this air conditioning system is mounted on a vehicle. The air blower A includes a drive control unit CL that controls the drive of the above-described motor main body M. The drive control unit CL is functionally achieved by the electronic components mounted on the above-described printed circuit board PB, specifically, by a CPU, a ROM, a RAM, and the like. The motor main body M and the drive control unit CL are an example of a motor device. The motor main body M is a three-phase brushless motor. The coils 30 described above are for three phases of U phase, V phase, and W phase. The drive control unit CL detects the rotational position of the rotor 40 based on the back electromotive force in any of the U-phase, V-phase and W-phase coils, and controls energization of each phase of the coils 30 based on the detection result. The motor main body M is a sensor less motor which does not have a sensor for detecting the rotational position of the rotor 40.

The air conditioning system includes an air blower A, an electronic control unit (ECU) 1 controlling drive of the air blower A, and a switch SW operated by a user. The switch SW is capable of adjusting ON/OFF of the air conditioning system and the output of the air conditioning system. Specifically, the switch SW is capable of switching the output of the air conditioning system, by the user, to any one of “Low” meaning relatively small, “middle” meaning substantially middle, “high” meaning relatively large, and “off”. The ECU 1 outputs a voltage or a PWM signal to the drive control unit CL according to the operation signal from the switch SW. The magnitude of the voltage or the duty ratio of the PWM signal is output from the ECU 1 to the drive control unit CL is preset corresponding to “Low”, “Middle”, and “High”. A target value of the rotational speed of the rotor 40 corresponding to the voltage or the PWM signal input from the ECU 1 is stored in advance in the ROM of the drive control unit CL. Therefore, when the voltage or the PWM signal is input from the ECU 1, the drive control unit CL performs feedback control of energization of the coils 30 so that the rotational speed of the rotor 40 reaches a target value. Additionally, the rotational speed of the rotor 40 is calculated by the drive control unit CL based on the above-described electromotive force. Further, the drive control unit CL performs the feedback control of the energization of the coils 30 so that the rotational speed of the rotor 40 does not fall below a threshold value at which the detection of the rotational position of the rotor 40 based on the back electromotive force described above is impossible. This threshold value is set to be lower than any of the target values described above. The rotor 40 starts being rotated by forced commutation. The drive control unit CL starts the feedback control, after the rotational speed by forced commutation exceeds the threshold value and the back electromotive force is obtained.

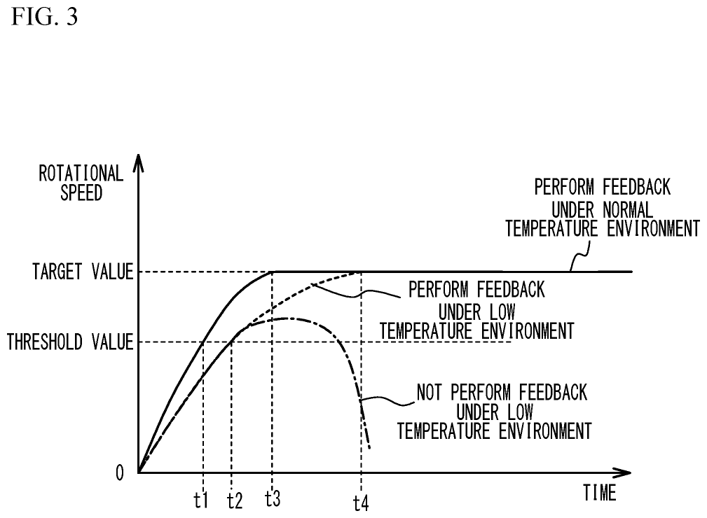

Next, a description will be given of a change in the rotational speed of the rotor 40. FIG. 3 is a time chart illustrating the change in the rotational seed of the rotor 40. A vertical axis indicates the rotational speed, and a horizontal axis indicates the elapsed time. First, a description will be given of the change in the rotational speed of the rotor 40 in a case of performing the feedback control under normal temperature environment. In FIG. 3, the rotational speed of the rotor 40 in this case is indicated by a solid line. When the drive voltage starts being applied to the coils 30 based on command from the ECU 1, the preset drive voltage for forced commutation of the rotor 40 starts being applied to each coil 30, and then this forced commutation causes the rotational speed of the rotor 40 to exceed the threshold value (time t1). Next, the energization of the coils 30 is feedback-controlled so that the rotational speed of the rotor 40 reaches the target value. As a result, the rotational speed of the rotor 40 reaches the target value within a predetermined period after the drive voltage starts being applied to the coil 30 (time t3). In addition, the duty ratio of the drive voltage is variably controlled between time t1 when the rotational speed exceeds the threshold value and time t3 when the rotational speed reaches the target value.

Next, a description will be given of the change in the rotational speed of the rotor 40 in a case of performing the feedback control under low temperature environment. In FIG. 3, the rotational speed of the rotor 40 in this case is indicated by a dotted line. Since the motor main body M includes the oil-retaining bearing 70 as described above, the viscosity of the oil of the oil-retaining bearing 70 increases under low temperature environment, and the rotational resistance between the rotational shaft 42 and the oil-retaining bearing 70 increases. For this reason, even when the drive voltage for the forced commutation is simply applied to the coils 30 based on the command from the ECU 1 under low temperature, the rotational speed of the rotor 40 may not exceed the threshold value. In response to this, the application of the drive voltage for the forced commutation to the coils 30 is repeatedly performed. By repeating the application of the drive voltage for the forced commutation, the temperature of the coils 30 increases, and then an increase in the temperature of the oil-retaining bearing 70 is promoted via the housing 60. Since the temperature of the oil of the oil-retaining bearing 70 increases and the viscosity decreases in response to this, the rotational speed of the rotor 40 exceeds the threshold value (time t2). Therefore, since the coils 30 are preferably in thermal contact with the oil-retaining bearing 70, the coils 30 and the oil-retaining bearing 70 are assembled into each other via the housing 60 having thermal conductivity. The housing 60 is made of, for example, a metal having good thermal conductivity, such as a cut part made of brass or a pressed part made from plated sheet steel, but is not limited thereto and may be made of resin. In a case of resin, in order to ensure thermal conductivity, it is preferable to use the resin to which an additive such as glass filler, talc, carbon or the like is added. The duty ratio of the drive voltage applied to each coil 30 for the forced commutation is constant. Additionally, when the duty ratio of the drive voltage for the forced commutation is large, the rotational speed of the rotor 40 is capable of reaching the threshold value in a short time. However, the load on the electronic components might increase, and the noise might increase. It is therefore preferable to set an appropriate value. After the rotational speed of the rotor 40 exceeds the threshold value due to the forced commutation, the energization of the coils 30 is controlled so that the rotational speed of-the rotor 40 does not fall below the threshold value by the feedback control as described above. Specifically, the duty ratio of the drive voltage applied to the coils 30 increases, as compared with the case under normal temperature environment. Thus, the rotational speed is controlled so as not to fall below the threshold value even under low temperature environment, and it takes long time for the rotational speed to reach the target value as compared with the case under normal temperature environment, but the rotational speed is finally controlled to the target value (time t4).

Next, a description will be given of the change in the rotational speed of the rotor 40 on the assumption that the feedback control is not performed under low temperature environment. In FIG. 3, the rotational speed of the rotor 40 in this case is indicated by an alternate long and short dash line. Since the rotational resistance of the rotor 40 increases under low temperature environment as described above, although the rotational speed exceeds the above-described threshold value due to the forced commutation, the rotational speed falls below the threshold value again due to the increase in the rotational resistance. Since the feedback control is not performed and the duty ratio of the drive voltage applied to the coils 30 is the same as under normal temperature environment, so sufficient rotational force is not capable of being applied to a large rotational resistance as compared to under normal temperature, and then the rotational speed decreases. When the rotational speed is lower than the threshold value, the rotational position of the rotor 40 is not capable of being detected, and the drive control unit CL is not capable of appropriately controlling the rotation of the rotor 40.

However, since the rotational speed is feedback-controlled so as not to fall below the threshold value in the present embodiment as described above, the rotation of the rotor 40 is appropriately controlled. A clearance for forming an oil film is provided between the oil-retaining bearing 70 and the rotational shaft 42 rotatably supported by the oil-retaining bearing 70. This clearance becomes smaller at a low temperature and becomes larger at a high temperature, due to the difference in the thermal expansion coefficient between the oil-retaining bearing 70 and the rotational shaft 42. Further, the rotational load becomes larger as the clearance becomes smaller. However, the large clearance causes the large vibration. In the present embodiment, the Motor device for the vehicle-mounted seat air conditioner is described. However, since use at high temperature as well as low temperature is required, the setting of the clearance is set to 10 micrometers or less at normal temperature,

While the exemplary embodiments of the present invention have been illustrated in detail, the present invention is not limited to the above-mentioned embodiments, and other embodiments, variations and modifications may be made without departing from the scope of the present invention.

1. A motor device comprising:
a motor body including a rotor, multi-phase coils for rotating the rotor, and an oil-retaining bearing supporting the rotor for rotation; and
a drive control unit detecting a position of the rotor based on counter electromotive force of any of the multi-phase coils, and controlling energization of the multi-phase coils according to the position of the rotor,
wherein the drive control unit feedback-controls energization of the multi-phase coils such that rotational speed of the rotor does not fall below a threshold value at which detection of rotational position of the rotor based on the counter electromotive force is impossible.

2. The motor device according to claim 1, wherein the rotor rotates a centrifugal multi-blade fan.

3. The motor device according to claim 1, wherein the rotor is an outer rotor.

4. The motor device according to claim 1, wherein the drive control unit repeats forced commutation until a rotational speed of the rotor exceeds the threshold value.

5. The motor device according to claim 4, wherein a duty ratio of voltage applied to each of the multi-phase coils is constant at time of the forced commutation.

6. The motor device according to claim 1, wherein the oil-retaining bearing is in thermal contact with the multi-phase coils through a housing.

7. A vehicle-mounted seat air conditioner comprising the motor device according to claim 1.
